(19) United States
(12) Patent Application Publication
(10) Pub. No.: US 2024/0351089 A1
(43) Pub. Date: Oct. 24, 2024

(54) FLANGED AND TAPERED PIN FOR METHOD TO AUTOMATE PART LOADING AND UNLOADING

(71) Applicant: The Boeing Company, Arlington, VA (US)

(72) Inventors: Donald Lloyd CONAWAY, Gig Harbor, WA (US); Larry Dean HEFTI, Auburn, WA (US); David James FALCONER FYVIE, Clarkston (GB)

(73) Assignee: The Boeing Company, Arlington, VA (US)

(21) Appl. No.: 18/302,225

(22) Filed: Apr. 18, 2023

(51) Int. Cl. B21D 43/10; B21D 37/10; B21D 37/16

(52) U.S. Cl. CPC B21D 43/105; B21D 37/10; B21D 37/16

(57) ABSTRACT

A forming die for forming a part is disclosed. The forming die includes a lower forming die portion comprising a lower pin receiving opening for receiving a lower portion of a removable securing pin that secures a lower surface of a part to be formed to the lower forming die; and an upper forming die portion, positionable above the lower forming die portion, comprising an upper pin receiving opening for receiving an upper portion of the removable securing pin that secures an upper surface of the part to be formed to the upper forming die portion.

### FIELD

This application is directed to flanged and tapered pins for method to automate part loading and unloading.

### BACKGROUND

Conventional presses, such as hot-forming presses are expensive. For example, in the aerospace industry, a hot-forming press, capable of processing large parts, may cost in excess of US$2.5 million and even as much as US$10 million. Moreover, conventional hot-forming presses require expensive maintenance and are subject to unpredictable down-time, which adversely effects manufacturing cycle time. In addition, if a hot-forming press fails in operation, expensive rework of parts, being processed by the press at the time of failure, is often needed. As a worst-case scenario, such parts must be scrapped, resulting in significant additional costs.

Part loading of hot forming tools normally is done manually and requires an operator to wear heat protective equipment/clothing. During the load/unload step, operators are required to be in close contact with the part, the tool, and the press components which can be in excess of 1700° F. Manually loaded and unloaded parts can result in variations to part contour due to operators employing different load and unload methods. Automated loading and unloading could provide a safer environment for operators requiring less close interaction with hot components.

### SUMMARY

According to examples of the present disclosure, a forming die for forming a part is disclosed. The forming die comprises a lower forming die portion comprising a lower pin receiving opening for receiving a lower portion of a removable securing pin that secures a lower surface of a part to be formed to the lower forming die; and an upper forming die portion, positionable above the lower forming die portion, comprising an upper pin receiving opening for receiving an upper portion of the removable securing pin that secures an upper surface of the part to be formed to the upper forming die portion.

Various additional features can be included in the forming die for forming the part including one or more of the following features. The lower forming die portion is housed in a lower hot box portion, wherein the lower hot box portion comprises a lower housing, a lower heating platen, received within the lower housing and configured to support the lower forming die portion, and a lower hot box portion pin receiving opening for receiving the lower portion of the removable securing pin that secures the lower surface of the part to be formed to the lower housing and the lower heating platen. The upper forming die portion is housed in an upper hot box portion, positionable above the lower hot box portion, wherein the upper hot box portion comprises an upper housing, an upper heating platen, received within the upper housing and configured to support the upper forming die portion, and an upper hot box portion pin receiving opening for receiving the upper portion of the removable securing pin that secures an upper surface of the part to be formed to the upper housing and the upper heating platen. The forming die further comprises the removable securing pin. The lower portion of the removable securing pin comprises a tapered surface that is clearance fit into the lower pin receiving opening that is reciprocally tapered to provide for removal and positioning of the part. The upper portion of the removable securing pin comprises a flange that provides a ledge on which the part rests, enables lifting of the part, and that connects a top surface of the lower pin receiving opening. The upper portion of the removable securing pin comprises a recessed ridge that allows for gripping the removeable securing pin. The end effector further comprises a thermal pad that provides a thermal break between the lower forming die portion and a gripper from an end effector. The lower hot box portion and the upper hot box portion are removable from a press assembly.

According to examples of the present disclosure, a hot box for hot forming a part is disclosed. The hot box comprises a lower hot box portion, comprising: a lower housing, a lower heating platen, received within the lower housing and configured to support a lower forming die portion, and a lower pin receiving opening for receiving a lower portion of a removable securing pin that secures a lower surface of a part to be formed to the lower housing and the lower heating platen and an upper hot box portion, positionable above the lower hot box portion and comprising: an upper housing, an upper heating platen, received within the upper housing and configured to support an upper forming die portion, and a upper pin receiving opening for receiving an upper portion of the removable securing pin that secures an upper surface of the part to be formed to the upper housing and the upper heating platen.

Various additional features can be included in the hot box for forming a part including one or more of the following features. The hot box further comprises the removable securing pin. The lower portion of the removable securing pin comprises a tapered surface that is clearance fit into the lower pin receiving opening that is reciprocally tapered to provide for removal and positioning of the part. The upper portion of the removable securing pin comprises a flange that provides a ledge on which the part rests, enables lifting of the part, and that connects a top surface of the lower pin receiving opening. The upper portion of the removable securing pin comprises a recessed ridge that allows for gripping the removeable securing pin. The end effector further comprises a thermal pad that provides a thermal break between the lower forming die portion and a gripper from an end effector.

According to examples of the present disclosure, system is disclosed. The system comprises an end effector; and a gripper attached to the end effector that grips a securing pin that secures a part to a lower hot box portion of a hot box, wherein the securing pin comprises a tapered lower body portion, a flange arranged between the lower body portion and an upper body portion, and a recessed ridge arranged above the flange that allows the gripper to hold the securing pin. In some examples, the system comprises a part handling robot, a user-controlled platform, a computer-controlled platform, or a part-handling frame.

According to examples of the present disclosure, a part securing pin is disclosed. The part securing pin comprises a tapered lower body portion; an upper body portion; a flange arranged between the lower body portion and the upper body portion; and a recessed ridge arranged above the flange that allows a gripper to hold the hot box securing pin.

According to examples of the present disclosure, a method for securing part to be formed in a hot box or superplastic forming (SPF) press assembly is disclosed. The method comprises securing the part to be formed to a platform using a securing pin, wherein the platform comprises an end effector and a gripper attached to the end effector a securing pin; moving the part to be formed using the securing pin to a lower hot box portion of the hot box in a hot box press assembly; and releasing the part by actuating the gripper to release the securing pin.

The following is a non-exhaustive list of examples, which may or may not be claimed, of the subject matter according to the invention.

One example of the subject matter, according to the invention, relates to a press. The press comprises a lower press assembly and an upper press assembly. The lower press assembly is movable along a vertical axis and comprises a lower forming die portion, and a lower hot box portion, configured to receive the lower forming die portion. The upper press assembly is movable along the vertical axis above the lower press assembly and comprises an upper forming die portion, and an upper hot box portion. The upper hot box portion is configured to receive the upper forming die portion so that the upper forming die portion is positioned opposite the lower forming die portion. The lower forming die portion and the upper forming die portion are configured to apply a forming pressure to a workpiece that is received between the lower forming die portion and the upper forming die portion. The lower hot box portion and the upper hot box portion are configured to heat the workpiece.

By having both the lower press assembly and the upper press assembly movable along a vertical axis, the component(s) of the press that apply a forming force to generate the forming pressure (i.e., the tonnage of the press) for application to the workpiece need not have a significant stroke length that accounts both for operative placement of the workpiece and removal of a formed part from the press and for application of the forming force. Similarly, the component(s) of the press that apply a forming force to generate the forming pressure need not have a stroke length that also accounts for removal and replacement of the lower forming die portion and the upper forming die portion. Accordingly, the component(s) of the press that apply the forming force to generate the forming pressure undergo less stress over the same number of cycles than prior art presses, thus requiring less maintenance and repair over the lifetime of the press.

Another example of the subject matter, according to the invention, relates to a hot box of a press. The hot box comprises a lower hot box portion and an upper hot box portion. The lower hot box portion comprises a lower housing, a lower heating platen, and a lower insulation layer. The lower heating platen is received within the lower housing and is configured to support a lower forming die portion. The lower insulation layer is positioned between the lower housing and the lower heating platen. The upper hot box portion is positionable above the lower hot box portion and comprises an upper housing, an upper heating platen, and an upper insulation layer. The upper heating platen is received within the upper housing and is configured to support an upper forming die portion. The upper insulation layer is positioned between the upper housing and the upper heating platen. The lower hot box portion and the upper hot box portion provide a thermal barrier around a workpiece that is received between the lower forming die portion and the upper forming die portion, when the lower hot box portion and the upper hot box portion are in contact with each other.

The hot box provides a thermal barrier to maintain the heat delivered to the lower forming die portion and the upper forming die portion, and thus to the workpiece, when the press is operatively forming a part from the workpiece. The lower housing provides structure for supporting the other components of the lower hot box portion. The lower insulation layer insulates the lower heating platen, which is configured to support the lower forming die portion and conduct heat thereto, and thereby facilitates efficient heating of the lower forming die portion by restricting conduction away from the lower forming die portion. Similarly, the upper housing provides structure for supporting the other components of the upper hot box portion. The upper insulation layer insulates the upper heating platen, which is configured to support the upper forming die portion and conduct heat thereto, and thereby facilitates efficient heating of the upper forming die portion by restricting conduction away from the upper forming die portion.

Yet another example of the subject matter, according to the invention, relates to a method of forming a workpiece. The method comprises a step of vertically moving both a lower press assembly and an upper press assembly to a loading configuration, in which the lower press assembly and the upper press assembly are spaced-apart to receive the workpiece. The method comprises a step of positioning the workpiece between a lower forming die portion of the lower press assembly and an upper forming die portion of the upper press assembly. The method further comprises a step of vertically moving both the lower press assembly and the upper press assembly to a closed configuration, in which the lower press assembly and the upper press assembly are positioned to apply a forming pressure to the workpiece. The method also comprises a step of immobilizing the upper press assembly. The method further comprises a step of moving the lower press assembly toward the upper press assembly to apply the forming pressure to the workpiece. The method also comprises a step of heating the workpiece.

By vertically moving both the lower press assembly and the upper press assembly between the loading configuration and the closed configuration, the component(s) of the press that apply a forming force to generate the forming pressure (i.e., the tonnage of the press) for application to the workpiece need not have a significant stroke length that accounts both for operative placement of the workpiece and removal of a formed part from the press and for application of the forming force. Similarly, the component(s) of the press that apply a forming force to generate the forming pressure need not have a stroke length that also accounts for removal and replacement of the lower forming die portion and the upper forming die portion. Accordingly, the component(s) of the press that apply the forming force to generate the forming pressure undergo less stress over the same number of cycles than prior art presses, thus requiring less maintenance and repair over the lifetime of the press.

By immobilizing the upper press assembly, the component(s) associated with vertically moving the upper press assembly need not be capable of applying a forming force that is sufficient to generate the required forming pressure to operatively deform the workpiece. Rather, only the component(s) associated with vertically moving the lower press assembly need be capable of applying a forming force that is sufficient to generate the required forming pressure to operatively deform the workpiece. As a result, the component(s) associated with vertically moving the upper press assembly may be significantly less expensive than the component(s) associated with vertically moving the lower press assembly.

Yet another example of the subject matter, according to the invention, relates to a method of forming a workpiece. The method comprises a step of delivering an actively determined amount of heat to distinct lower regions of a lower heating platen of a lower hot box portion of a hot box of a press or to distinct upper regions of an upper heating platen of an upper hot box portion of the hot box.

By vertically moving both the lower press assembly and the upper press assembly between the loading configuration and the closed configuration, the component(s) of the press that apply a forming force to generate the forming pressure (i.e., the tonnage of the press) for application to the workpiece need not have a significant stroke length that accounts both for operative placement of the workpiece and removal of a formed part from the press and for application of the forming force. Similarly, the component(s) of the press that apply a forming force to generate the forming pressure need not have a stroke length that also accounts for removal and replacement of the lower forming die portion and the upper forming die portion. Accordingly, the component(s) of the press that apply the forming force to generate the forming pressure undergo less stress over the same number of cycles than prior art presses, thus requiring less maintenance and repair over the lifetime of the press.

By immobilizing the upper press assembly, the component(s) associated with vertically moving the upper press assembly need not be capable of applying a forming force that is sufficient to generate the required forming pressure to operatively deform the workpiece. Rather, only the component(s) associated with vertically moving the lower press assembly need be capable of applying a forming force that is sufficient to generate the required forming pressure to operatively deform the workpiece. As a result, the component(s) associated with vertically moving the upper press assembly may be significantly less expensive than the component(s) associated with vertically moving the lower press assembly.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 shows a front view of a hot box in a press according to examples of the present disclosure;

FIG. 2 shows open front perspective view 200 of hot box 102 of FIG. 1 according to examples of the present disclosure;

FIG. 3 shows a front perspective view 300 of lower hot box portion 108 of FIG. 2 according to examples of the present disclosure;

FIG. 4A shows an isolated front perspective view 400 of part load/unload arm 206 according to examples of the present disclosure;

FIG. 4B shows a detailed view 420 of a portion of FIG. 4A according to examples of the present disclosure;

FIG. 5 shows a reverse perspective of FIG. 4A according to examples of the present disclosure;

FIG. 6 shows a side perspective view 600 of FIG. 5 apart from lower forming die portion 202 according to examples of the present disclosure;

FIG. 7 shows a detailed view 700 of one end of FIG. 4A according to examples of the present disclosure;

FIG. 8 shows a method 800 for securing part to be formed in a hot box or superplastic forming (SPF) press assembly according to examples of the present disclosure; and

FIG. 9 illustrates an airplane according to examples of the present disclosure.

FIG. 10 shows a partial cross sectional view 1000 of upper hot box portion 106 and lower hot box portion 108 according to examples of the present disclosure. As shown in FIG. 10, part 204 is positioned onto lower hot box portion 108.

FIG. 11 shows a cross sectional view 1100 hot box 102 of FIG. 1 according to examples of the present disclosure.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

In the following description, numerous specific details are set forth to provide a thorough understanding of the disclosed concepts, which may be practiced without some or all of these particulars. In other instances, details of known devices and/or processes have been omitted to avoid unnecessarily obscuring the disclosure. While some concepts will be described in conjunction with specific examples, it will be understood that these examples are not intended to be limiting.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

Reference herein to “one example” means that one or more feature, structure, or characteristic described in connection with the example is included in at least one implementation. The phrase “one example” in various places in the specification may or may not be referring to the same example.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

Illustrative, non-exhaustive examples, which may or may not be claimed, of the subject matter according to the present disclosure are provided below.

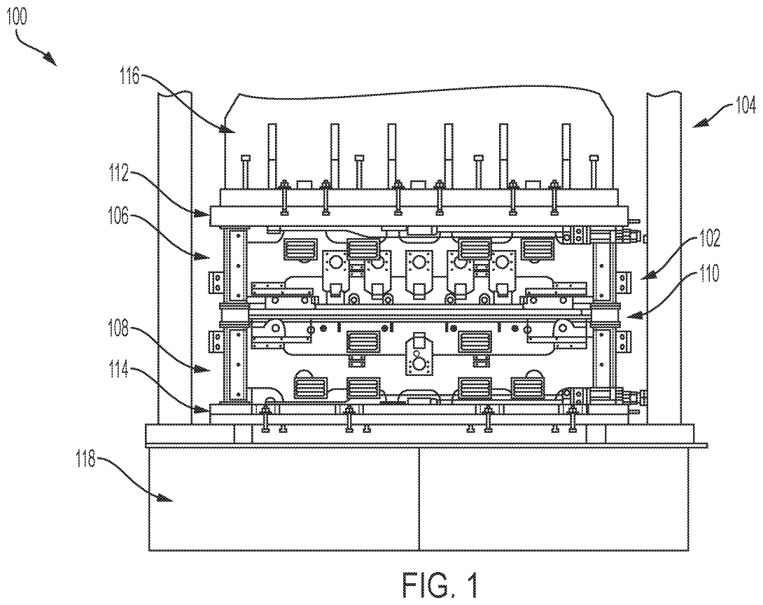

FIG. 1 shows front view 100 of hot box 102 in press 104 according to examples of the present disclosure. Hot box 102 can also be termed “hot-box” or “hotbox” depending on the particular usage in the industry. Hot box 102 comprises lower hot box portion 108 and upper hot box portion 106. Lower hot box portion 108 and upper hot box portion 106 when in a closed position use a flexible heat seal 110 to close any gaps. Lower hot box portion 108 comprises lower housing 120 and lower heating platen 1004 that is received within lower housing 120. Upper hot box portion 106 comprises upper housing 122 and upper heating platen 1010 that is received within upper housing 122. Upper base plate 112, sometimes called an upper strongback or just strongback, is arranged on a top surface of upper hot box portion 106 and lower base plate 114, sometimes called a lower strongback or just strongback, is arranged on a bottom surface of lower hot box portion 108. Upper base plate 112 and lower base plate 114 provide structural reinforcement to hot box 102 and can be composed of materials, including but are not limited to, oxidation-corrosion-resistant materials such as austenitic nickel-chromium-based superalloys. Other suitable materials can be used as is known in the industry.

Press 104 comprises lower press assembly 118 and upper press assembly 116. For example, press 104 can be a superplastic forming (SPF) press or a hot-forming press. Other types of presses that perform the functions described herein can also be used. Lower press assembly 118 and/or upper press assembly 116 can be movable along a vertical axis. Hot box 102 is received between lower press assembly 118 and upper press assembly 116. Upper hot box portion 106 is configured to receive an upper forming die portion and lower hot box portion 108 is configured to receive a lower forming die portion so that the upper forming die portion is positioned opposite the lower forming die portion. The lower forming die portion and the upper forming die portion are configured to apply a forming pressure to a workpiece that is received between the lower forming die portion and the upper forming die portion. Lower hot box portion 108 and upper hot box portion 106 are configured to form the workpiece.

By having both lower press assembly 118 and upper press assembly 116 movable along a vertical axis, the component(s) of press 104 that apply a forming force to generate the forming pressure (i.e., the tonnage of press 104) for application to the workpiece need not have a significant stroke length that accounts both for operative placement of the workpiece and removal of a formed part from press 104 and for application of the forming force. Similarly, the component(s) of press 104 that apply a forming force to generate the forming pressure need not have a stroke length that also accounts for removal and replacement of the lower forming die portion and the upper forming die portion. Accordingly, the component(s) of press 104 that apply the forming force to generate the forming pressure undergo less stress over the same number of cycles than prior art presses, thus requiring less maintenance and repair over the lifetime of press 104. In some examples, hot box 102 can be used in a conventional press, a conventional hot-forming press, or a conventional superplastic forming press where a lower press assembly is fixed and the upper press assembly is moveable.

In some examples, lower hot box portion 108 and upper hot box portion 106 are structures that not only support the lower forming die portion and the upper forming die portion, respectively, but also may be used to heat the lower forming die portion and the upper forming die portion for operative forming of the workpiece.

Referring generally to FIG. 1, lower hot box portion 108 and upper hot box portion 106 are configured to heat the workpiece to a temperature of at least 250° C., at least 500° C., or at least 750° C., or to a temperature in the range of 250-1000° C.

Heating the workpiece to a desired temperature enables an operator of press 104 to control the yield strength, hardness, and ductility of the workpiece, and ultimately of a part being formed from the workpiece. That is, depending on the material selection for the workpiece, a temperature or temperature range may be selected, for example, above the recrystallization temperature of the material to avoid string hardening of the material during the forming process. Moreover, heating the workpiece allows for high-strength materials to be formed at lower forming pressures than would be required in a cold-forming process.

Illustrative, non-exclusive examples of materials that may be used for the workpiece include (but are not limited to) various aluminum and titanium alloys and steels.

Referring generally to FIG. 1, the forming pressure results from a forming force of at least 50 metric tons, at least 100 metric tons, at least 300 metric tons, at least 500 metric tons, at least 700 metric tons, at least 1000 metric tons, or at least 2000 metric tons, or in the range of 50-2250 metric tons. Forming pressures are selected based on material properties of the workpiece and the complexity of a part being formed from the workpiece. Moreover, higher forming pressures may provide for lower temperature requirements to result in desired material properties of the part being formed from the workpiece.

Referring generally to FIG. 1, lower press assembly 118 and upper press assembly 116 are configured to be vertically moved to a loading configuration, in which lower press assembly 118 and upper press assembly 116 are spaced-apart to receive hot box 102. Lower press assembly 118 and upper press assembly 116 are configured to be vertically moved to a closed configuration, in which lower press assembly 118 and upper press assembly 116 are positioned to apply the forming pressure to hot box 102, and thus to the workpiece between upper hot box portion 106 and lower hot box portion 108. The loading configuration provides sufficient space for an operator or platform portion, such as a robotic arm, of a platform 506, such as a part handling robot, to operatively place hot box 102 between lower press assembly 118 and upper press assembly 116. The closed configuration positions lower press assembly 118 and upper press assembly 116 for application of the forming pressure to the workpiece.

In some examples, the loading configuration also provides sufficient space for an operator or a platform arm, such as a robotic arm, to remove hot box 102 from lower press assembly 118 and upper press assembly 116 after press 104 has formed the part. Accordingly, in some examples, the loading configuration also may be referred to as an unloading configuration. Upper press assembly 116 is configured to be selectively locked in the closed configuration.

In some examples, by locking upper press assembly 116 in the closed configuration, the forming force required to generate the forming pressure to the workpiece need only be applied by lower press assembly 118. Accordingly, the component(s) of press 104 that vertically move upper press assembly 116 need not be capable of applying such high forces as may be required to generate a desired forming pressure, but rather need only be capable of moving upper press assembly 116 between at least the loading configuration and the closed configuration. Press 104 can further comprises an upper press head, at least one locking rod, and at least one rod clamp. Upper press assembly 116 is vertically movable relative to the upper press head. At least one locking rod is fixed to upper press assembly 116. At least one rod clamp is fixed to the upper press head and is configured to selectively clamp at least one locking rod to immobilize upper press assembly 116 relative to the upper press head. When at least one locking rod is clamped by at least one rod clamp, upper press assembly 116 is immobilized relative to the upper press head. Accordingly, when lower press assembly 118 applies the forming force to generate the forming pressure, upper press assembly 116 inherently applies an equal and opposite forming force for generation of the forming pressure that is applied to the workpiece for deformation thereof.

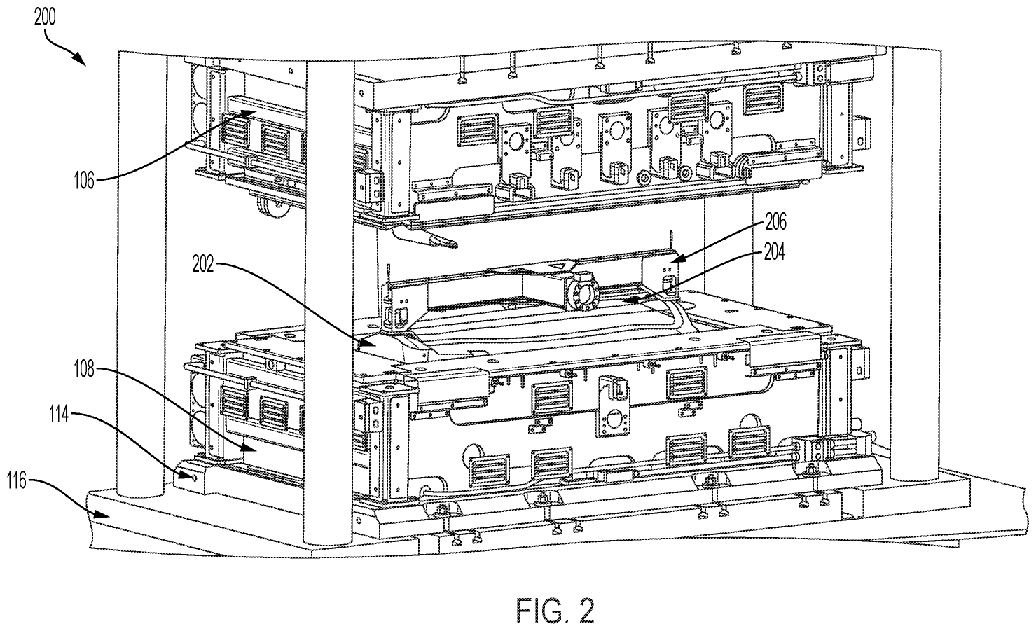

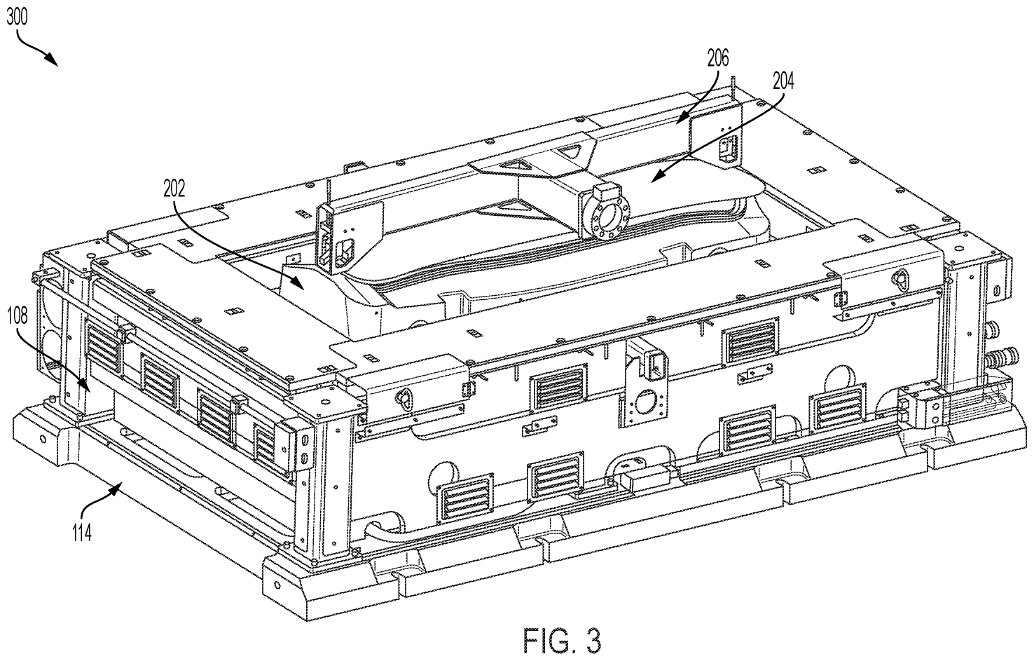

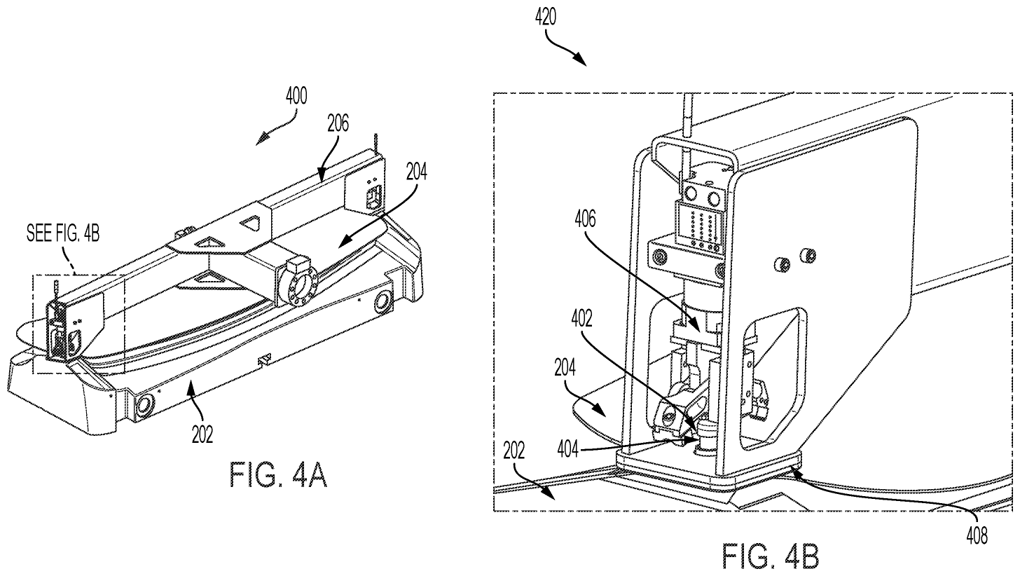

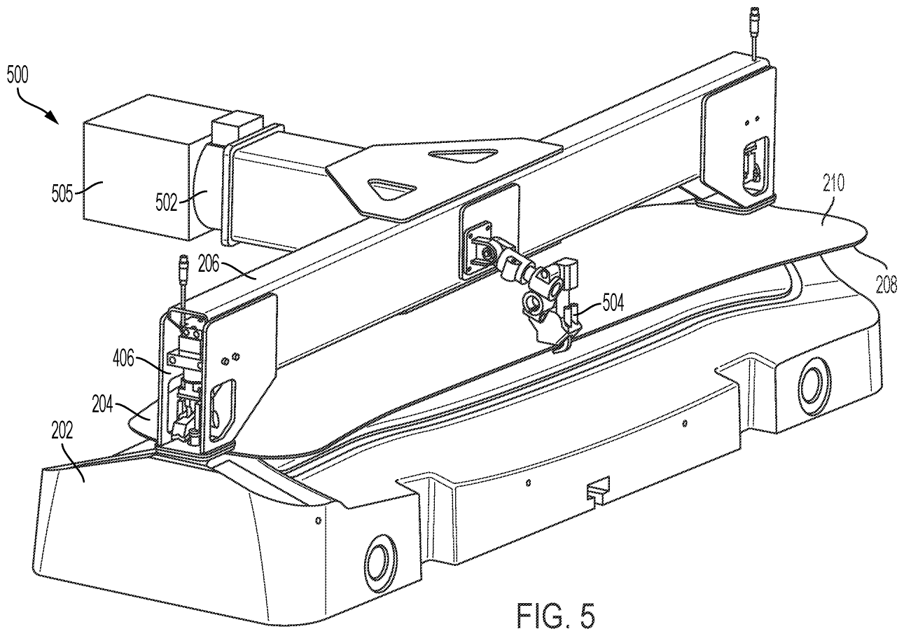

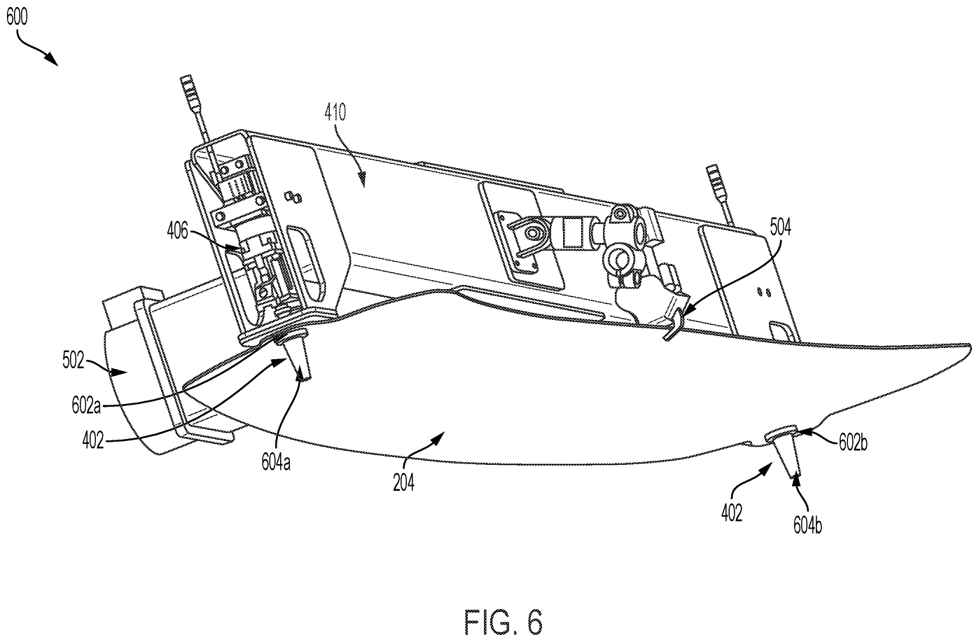

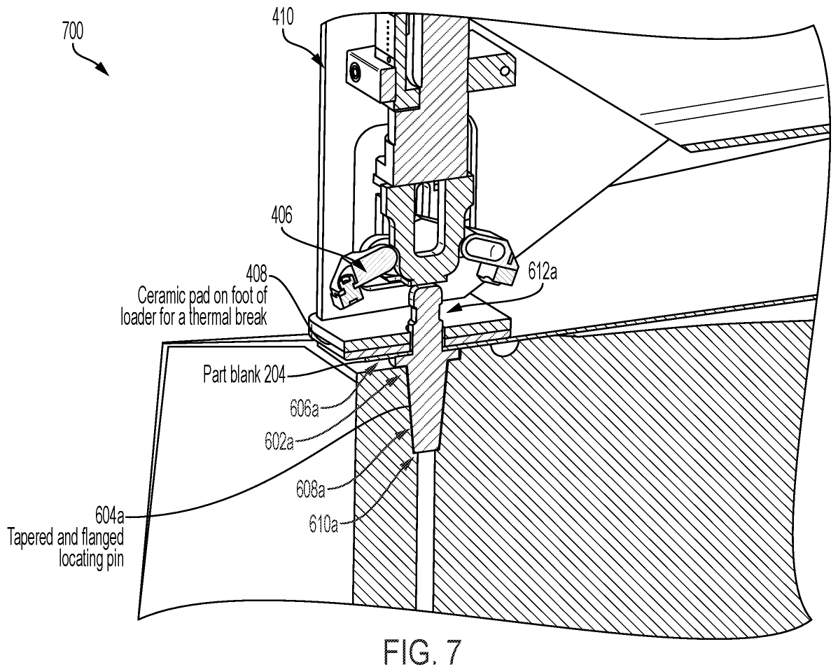

FIG. 2 shows open front perspective view 200 of hot box 102 of FIG. 1. FIG. 3 shows a front perspective view 300 of lower hot box portion 108 of FIG. 2 that is removed from press 104. As shown in FIG. 2 and FIG. 3, part load/unload arm 206 holds part 204 and positions part 204 onto and off lower forming die portion 202. FIG. 4A shows an isolated front perspective view 400 of part load/unload arm 206 holds part 204 and positions part 204 onto and off lower forming die portion 202 of FIG. 2 and FIG. 3. FIG. 4B shows a detailed view 420 of a portion of FIG. 4A. FIG. 5 shows a reverse perspective 500 of FIG. 4A. FIG. 6 shows a side perspective view 600 of FIG. 5 apart from lower forming die portion 202. FIG. 7 shows a detailed view 700 of one end of FIG. 4A. Part load/unload arm 206 can be made of a structure such as stainless steel, i.e., stainless steel 304 or 316, depending on a length of heat exposure. Part 204 comprises an upper surface 210 and lower surface 208. Part load/unload arm 206 comprises gripper 406 at each end of part load/unload arm 206. Removeable pin gripper 406 grips onto and holds removable securing pin 402. Removeable securing pin comprises lower portion securing 608a and upper portion 612a. Removable securing pin 402 is used for lifting and locating part 204 on a tool, such as lower forming die portion 202. Removable securing pin 402 comprises lower portion that has a tapered surface 604a and 604b that is clearance fitted into the lower pin receiving opening, such as lower pin receiving opening 606a of lower forming die portion 202 and lower hot box portion pin receiving opening 610a, that is reciprocally tapered to provide for removal and positioning of part 204. Removable securing pin 402 also comprises upper portion 612a that comprises recessed ridge 404 that allows for gripping removeable securing pin 402 and flange 602a and 602b that provides a ledge on which part 204 rests, enables lifting of part 204, and that connects a top surface of the lower pin receiving opening. Thermal pad 408 provides a thermal break between the lower forming die portion 202 and removable pin gripper 406 from an end effector. In some examples, thermal pad 408 can be a ceramic pad. Part load/unload arm 206 comprises attach point 502 for attaching a platform 506, such as a part handling robot or other handling device. Attach point 502 can be located outside of a hot area to reduce or eliminate the need to shield whatever the loader is robot, whether the loader is a platform, a robot, or a human. Part load/unload arm 206 also comprises part gripper 504 to hold a portion of part 204.

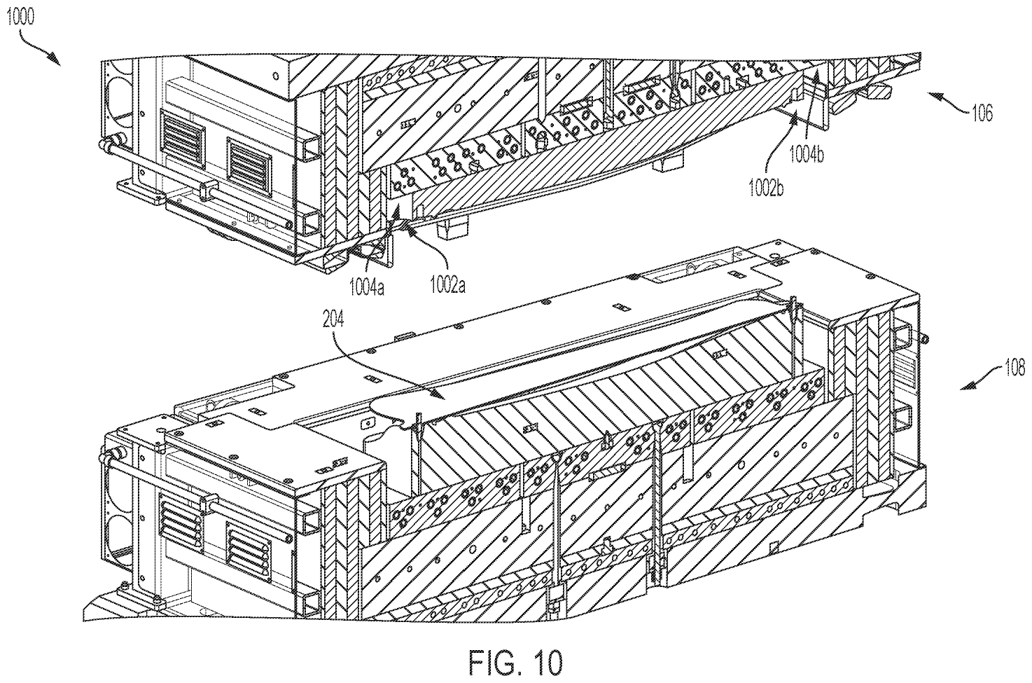

FIG. 10 shows a partial cross sectional view 1000 of upper hot box portion 106 and lower hot box portion 108 according to examples of the present disclosure. As shown in FIG. 10, part 204 is positioned onto lower hot box portion 108.

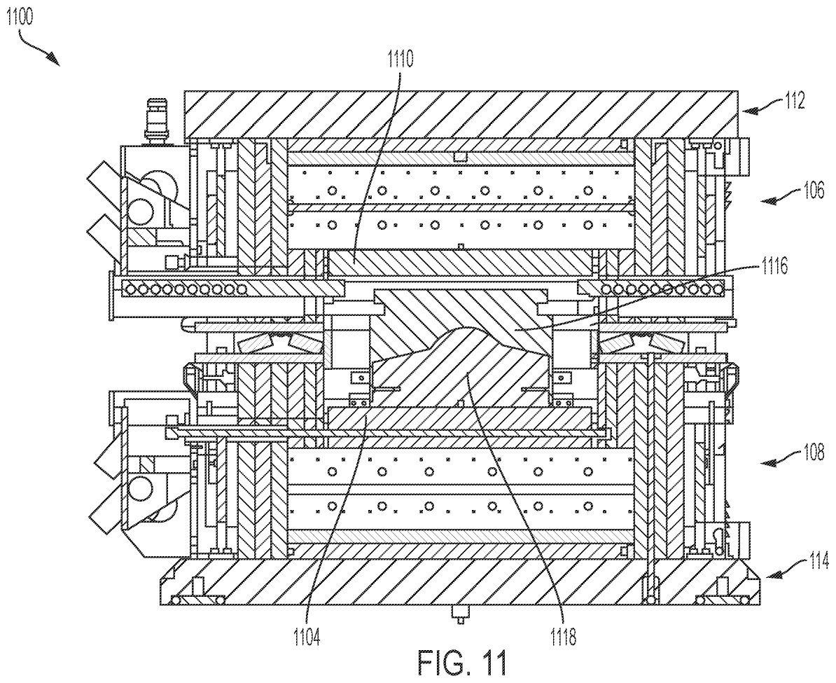

FIG. 11 shows a cross sectional view 1100 hot box 102 of FIG. 1 according to examples of the present disclosure. As shown in FIG. 11, lower hot box portion 108 comprises lower base plate 114 and lower heating platen 1004. Upper hot box portion 106 comprises upper base plate 112 and upper heating platen 1010. Lower hot box portion 108 and upper hot box portion 106 when joined use flexible heat seal 110 to close any air gaps. Die 1014, or forming tool, is arranged between lower hot box portion 108 and upper hot box portion 106. Die 1014 comprises upper forming die portion 1016 and lower forming die portion 1018.

As shown in FIG. 10 and FIG. 11, the upper forming die portion 1116 is positionable above the lower forming die portion 202 and comprises an upper pin receiving opening 1002a, 1002b for receiving an upper portion 612a of the removable securing pin 402 that secures an upper surface 210 of the part 204 to be formed to the upper forming die portion 1116. The upper forming die portion 1116 is housed in an upper hot box portion 106, positionable above the lower hot box portion 108, wherein the upper hot box portion 106 and comprises an upper housing 122, an upper heating platen 1110, received within the upper housing 122 and configured to support the upper forming die portion 1116, and an upper hot box portion pin receiving opening 1004a, 1004b for receiving the upper portion 612a of the removable securing pin 402 that secures an upper surface 210 of the part 204 to be formed to the upper housing 122 and the upper heating platen 1110.

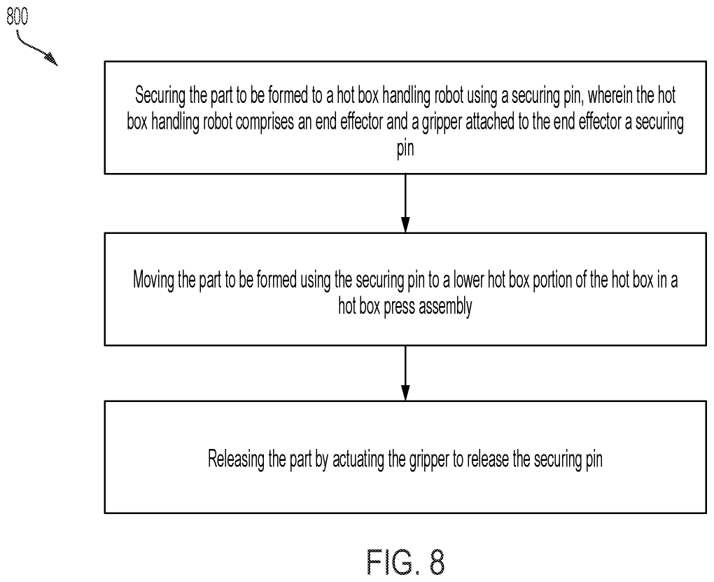

FIG. 8 shows a method 800 for securing part to be formed in a hot box or superplastic forming (SPF) press assembly. Method 800 comprises securing the part to be formed to a platform, such as a part handling robot, using a securing pin, wherein the platform comprises an end effector and a gripper attached to the end effector a securing pin, as in 802. Method 800 continues by moving the part to be formed using the securing pin to a lower hot box portion of the hot box in a hot box press assembly, as in 804. Method 800 continues by releasing the part by actuating the gripper to release the securing pin, as in 806.

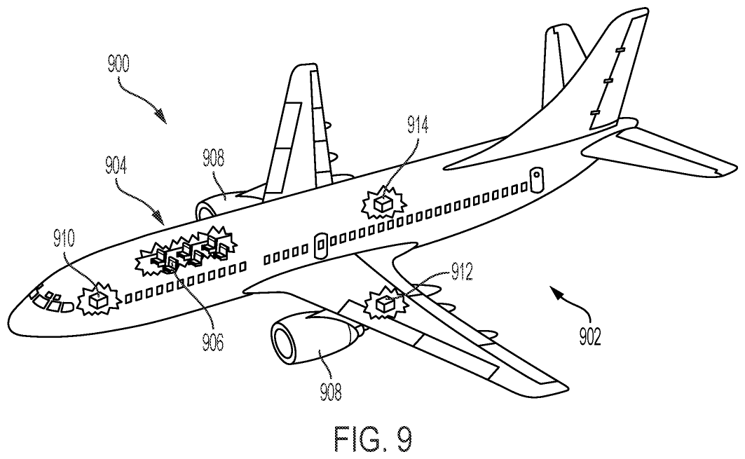

Examples of the present disclosure may be described in the context of aircraft manufacturing and method 800 as shown in FIG. 8 and aircraft 900 as shown in FIG. 9. During pre-production, illustrative method 800 may include specification and design of aircraft 900 and material procurement. During production, component and subassembly manufacturing and system integration of aircraft 900 may take place. Thereafter, aircraft 900 may go through certification and delivery to be placed in service. While in service, aircraft 900 may be scheduled for routine maintenance and service. Routine maintenance and service may include modification, reconfiguration, refurbishment, etc. of one or more systems of aircraft 900.

Each of the processes of illustrative method may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

As shown in FIG. 9, parts for aircraft 900 produced by illustrative method 800 may include airframe 902 with a plurality of high-level systems 904 and interior 906. Examples of high-level systems 904 include one or more of propulsion system 908, electrical system 910, hydraulic system 912, and environmental system 914. Any number of other systems may be included. Although an aerospace example is shown, the principles disclosed herein may be applied to other industries, such as the automotive industry. Accordingly, in addition to aircraft 900, the principles disclosed herein may apply to other vehicles, e.g., land vehicles, marine vehicles, space vehicles, etc.

Apparatus(es) and method(s) shown or described herein may be employed during any one or more of the stages of the manufacturing and method 800. For example, components or subassemblies corresponding to component and subassembly manufacturing may be fabricated or manufactured in a manner similar to components or subassemblies produced while aircraft 900 is in service. Also, one or more examples of the apparatus(es), method(s), or combination thereof may be utilized during production stages, for example, by substantially expediting assembly of or reducing the cost of aircraft 900. Similarly, one or more examples of the apparatus or method realizations, or a combination thereof, may be utilized, for example and without limitation, while aircraft 900 is in service and/or during maintenance and service.

Examples of the present disclosure can be described according to one or more of the following clauses.

Clause 1: A forming die for forming a part, the forming die comprising:
a lower forming die portion comprising a lower pin receiving opening for receiving a lower portion of a removable securing pin that secures a lower surface of a part to be formed to the lower forming die; and
an upper forming die portion, positionable above the lower forming die portion, comprising an upper pin receiving opening for receiving an upper portion of the removable securing pin that secures an upper surface of the part to be formed to the upper forming die portion.

Clause 2: The forming die of clause 1, wherein the lower forming die portion is housed in a lower hot box portion, wherein the lower hot box portion comprises a lower housing, a lower heating platen, received within the lower housing and configured to support the lower forming die portion, and a lower hot box portion pin receiving opening for receiving the lower portion of the removable securing pin that secures the lower surface of the part to be formed to the lower housing and the lower heating platen.

Clause 3: The forming die of clause 1 or clause 2, wherein the upper forming die portion is housed in an upper hot box portion, positionable above the lower hot box portion, wherein the upper hot box portion comprises an upper housing, an upper heating platen, received within the upper housing and configured to support the upper forming die portion, and an upper hot box portion pin receiving opening for receiving the upper portion of the removable securing pin that secures an upper surface of the part to be formed to the upper housing and the upper heating platen.

Clause 4: The forming die of any of clauses 1-3, further comprising the removable securing pin.

Clause 5: The forming die of any of clauses 1-4, wherein the lower portion of the removable securing pin comprises a tapered surface that is clearance fit into the lower pin receiving opening that is reciprocally tapered to provide for removal and positioning of the part.

Clause 6: The forming die of any of clauses 1-5, wherein the upper portion of the removable securing pin comprises a flange that provides a ledge on which the part rests, enables lifting of the part, and that connects a top surface of the lower pin receiving opening.

Clause 7: The forming die of any of clauses 1-6, wherein the upper portion of the removable securing pin comprises a recessed ridge that allows for gripping the removeable securing pin.

Clause 8: The forming die of any of clauses 1-7, further comprising a thermal pad that provides a thermal break between the lower forming die portion and a gripper from an end effector.

Clause 9: The forming die of any of clauses 1-8, wherein the lower hot box portion and the upper hot box portion are removable from a press assembly.

Clause 10: A hot box for hot forming a part, the hot box comprising:
a lower hot box portion, comprising: a lower housing, a lower heating platen, received within the lower housing and configured to support a lower forming die portion, and a lower pin receiving opening for receiving a lower portion of a removable securing pin that secures a lower surface of a part to be formed to the lower housing and the lower heating platen and
an upper hot box portion, positionable above the lower hot box portion and comprising: an upper housing, an upper heating platen, received within the upper housing and configured to support an upper forming die portion, and a upper pin receiving opening for receiving an upper portion of the removable securing pin that secures an upper surface of the part to be formed to the upper housing and the upper heating platen.

Clause 11: The hot box of clause 10, further comprising the removable securing pin.

Clause 12: The hot box of clause 10 or clause 11, wherein the lower portion of the removable securing pin comprises a tapered surface that is clearance fit into the lower pin receiving opening that is reciprocally tapered to provide for removal and positioning of the part.

Clause 13: The hot box of any of clauses 10-12, wherein the upper portion of the removable securing pin comprises a flange that provides a ledge on which the part rests, enables lifting of the part, and that connects a top surface of the lower pin receiving opening.

Clause 14: The hot box of any of clauses 10-13, wherein the upper portion of the removable securing pin comprises a recessed ridge that allows for gripping the removeable securing pin.

Clause 15: The hot box of any of clauses 10-14, further comprising a thermal pad that provides a thermal break between the lower forming die portion and a gripper from an end effector.

Clause 16: The hot box of any of clauses 10-15, wherein the lower hot box portion and the upper hot box portion are removable from a press assembly.

Clause 17: A platform comprising:
an end effector; and
a gripper attached to the end effector that grips a securing pin that secures a part to a lower hot box portion of a hot box, wherein the securing pin comprises a tapered lower body portion, a flange arranged between the lower body portion and an upper body portion, and a recessed ridge arranged above the flange that allows the gripper to hold the securing pin.

Clause 18: The platform of clause 17, wherein the system comprises a part handling robot, a user-controlled platform, a computer-controlled platform, or a part-handling frame.

Clause 19: A part securing pin comprising:
a tapered lower body portion;
an upper body portion;
a flange arranged between the lower body portion and the upper body portion; and
a recessed ridge arranged above the flange that allows a gripper to hold the hot box securing pin.

Clause 20: A method for securing part to be formed in a hot box or superplastic forming (SPF) press assembly, the method comprising:
securing the part to be formed to a platform using a securing pin, wherein the platform comprises an end effector and a gripper attached to the end effector a securing pin;
moving the part to be formed using the securing pin to a lower hot box portion of the hot box in a hot box press assembly; and
releasing the part by actuating the gripper to release the securing pin.

Different examples of the apparatus(es) and method(s) disclosed herein include a variety of components, features, and functionalities. It should be understood that the various examples of the apparatus(es) and method(s) disclosed herein may include any of the components, features, and functionalities of any of the other examples of the apparatus(es) and method(s) disclosed herein in any combination, and all of such possibilities are intended to be within the scope of the present disclosure.

Many modifications of examples set forth herein will come to mind to one skilled in the art to which the present disclosure pertains having the benefit of the teachings presented in the foregoing descriptions and the associated drawings.

Therefore, it is to be understood that the present disclosure is not to be limited to the specific examples illustrated and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims. Accordingly, parenthetical reference numerals in the appended claims are presented for illustrative purposes only and are not intended to limit the scope of the claimed subject matter to the specific examples provided in the present disclosure.

What is claimed is:

1. A forming die for forming a part, the forming die comprising:
a lower forming die portion comprising a lower pin receiving opening for receiving a lower portion of a removable securing pin that secures a lower surface of a part to be formed to the lower forming die; and
an upper forming die portion, positionable above the lower forming die portion, comprising an upper pin receiving opening for receiving an upper portion of the removable securing pin that secures an upper surface of the part to be formed to the upper forming die portion.

2. The forming die of claim 1, wherein the lower forming die portion is housed in a lower hot box portion, wherein the lower hot box portion comprises a lower housing, a lower heating platen, received within the lower housing and configured to support the lower forming die portion, and a lower hot box portion pin receiving opening for receiving the lower portion of the removable securing pin that secures the lower surface of the part to be formed to the lower housing and the lower heating platen.

3. The forming die of claim 2, wherein the upper forming die portion is housed in an upper hot box portion, positionable above the lower hot box portion, wherein the upper hot box portion comprises an upper housing, an upper heating platen, received within the upper housing and configured to support the upper forming die portion, and an upper hot box portion pin receiving opening for receiving the upper portion of the removable securing pin that secures an upper surface of the part to be formed to the upper housing and the upper heating platen.

4. The forming die of claim 1, further comprising the removable securing pin.

5. The forming die of claim 1, wherein the lower portion of the removable securing pin comprises a tapered surface that is clearance fit into the lower pin receiving opening that is reciprocally tapered to provide for removal and positioning of the part.

6. The forming die of claim 1, wherein the upper portion of the removable securing pin comprises a flange that provides a ledge on which the part rests, enables lifting of the part, and that connects a top surface of the lower pin receiving opening.

7. The forming die of claim 6, wherein the upper portion of the removable securing pin comprises a recessed ridge that allows for gripping the removeable securing pin.

8. The forming die of claim 1, further comprising a thermal pad that provides a thermal break between the lower forming die portion and a gripper from an end effector.

9. The forming die of claim 3, wherein the lower hot box portion and the upper hot box portion are removable from a press assembly.

10. A hot box for hot forming a part, the hot box comprising:
a lower hot box portion, comprising: a lower housing, a lower heating platen, received within the lower housing and configured to support a lower forming die portion, and a lower pin receiving opening for receiving a lower portion of a removable securing pin that secures a lower surface of a part to be formed to the lower housing and the lower heating platen and
an upper hot box portion, positionable above the lower hot box portion and comprising: an upper housing, an upper heating platen, received within the upper housing and configured to support an upper forming die portion, and an upper pin receiving opening for receiving an upper portion of the removable securing pin that secures an upper surface of the part to be formed to the upper housing and the upper heating platen.

11. The hot box of claim 10, further comprising the removable securing pin.

12. The hot box of claim 11, wherein the lower portion of the removable securing pin comprises a tapered surface that is clearance fit into the lower pin receiving opening that is reciprocally tapered to provide for removal and positioning of the part.

13. The hot box of claim 11, wherein the upper portion of the removable securing pin comprises a flange that provides a ledge on which the part rests, enables lifting of the part, and that connects a top surface of the lower pin receiving opening.

14. The hot box of claim 11, wherein the upper portion of the removable securing pin comprises a recessed ridge that allows for gripping the removeable securing pin.

15. The hot box of claim 10, further comprising a thermal pad that provides a thermal break between the lower forming die portion and a gripper from an end effector.

16. The hot box of claim 10, wherein the lower hot box portion and the upper hot box portion are removable from a press assembly.

17. A platform comprising:
an end effector; and
a gripper attached to the end effector that grips a securing pin that secures a part to a lower hot box portion of a hot box, wherein the securing pin comprises a tapered lower body portion, a flange arranged between the lower body portion and an upper body portion, and a recessed ridge arranged above the flange that allows the gripper to hold the securing pin.

18. The platform of claim 17, wherein the system comprises a part handling robot, a user-controlled platform, a computer-controlled platform, or a part-handling frame.

19. A part securing pin comprising:
a tapered lower body portion;
an upper body portion;
a flange arranged between the lower body portion and the upper body portion; and
a recessed ridge arranged above the flange that allows a gripper to hold the hot box securing pin.

20. A method for securing part to be formed in a hot box or superplastic forming (SPF) press assembly, the method comprising:
securing the part to be formed to a platform using a securing pin, wherein the platform comprises an end effector and a gripper attached to the end effector a securing pin;
moving the part to be formed using the securing pin to a lower hot box portion of the hot box in a hot box press assembly; and
releasing the part by actuating the gripper to release the securing pin.
